(19) United States
(12) Patent Application Publication
(10) Pub. No.: US 2004/0103018 A1
(43) Pub. Date: May 27, 2004

(54) Methods and systems for demand forecasting of promotion, cannibalization, and affinity effects

(76) Inventors: Edward D. Kim, Toronto (CA); Shireengul Islam, Markham (CA); Zheng Wu, Markham (CA); Sam Safarian, Richmond Hill (CA); Ejaz Haider, Markham (CA)

Correspondence Address: JAMES M. STOVER, NCR CORPORATION, 1700 SOUTH PATTERSON BLVD, WHQ4, DAYTON, OH, 45479, US

(21) Appl. No.: 10/305,894

(22) Filed: Nov. 27, 2002

(51) Int. Cl. G06F 17/60

(52) U.S. Cl. 705/10

(57) ABSTRACT

Methods and systems for demand forecasting are provided. Historical demand data for a related product is acquired. The historical demand data corresponds to a period of time during which a promoted product was promoted. The demand effect of the related product is determined during this period of time and used to project or forecast a demand for the related product when the promoted product is subsequently promoted. The demand effect can be positive or negative. A positive demand effect identifies an affinity relationship between the promoted product and the related product. A negative demand effect identifies a cannibalization relationship between the promoted product and the related product.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in any drawings hereto: Copyright© 2002, NCR Corp. All Rights Reserved.

### FIELD OF THE INVENTION

The present invention relates to demand forecasting, and in particular to methods and systems that determine demand forecasting for products affected by a promoted product.

### BACKGROUND OF THE INVENTION

Accurately determining demand forecasts for products are paramount concerns for organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, excessive inventory that exceeds a current demand can adversely impact the profits of an organization.

When one product is promoted, it can usually expect to experience an increase in demand. However, the promoted product can also either positively or negatively affect the demand of other related products. For example, when Coca-Cola® soft drinks are promoted by a sale, they will experience an increase in demand. But, during the period of time that Coca-Cola drinks are promoted Pepsi-Cola® soft drinks will experience a decrease demand. This concept is referred to as product cannibalization. In a like manner, a product such as potato chips may experience an increased demand during the period of time during which, Coca-Cola soft drinks are on sale. This concept is referred to as product affinity.

A multitude of demand forecasting models provide fairly accurate demand forecasting for products that are promoted. However, few techniques exist to accurately forecast demand for cannibalized and affinity products when a promoted product is actively, promoted. Most conventional approaches attempt to address this problem with linear regression techniques that isolate one type of promotion for a promoted product to determine the appropriate effect. For example, conventional approaches will have one technique for promotions that are made on television and a different technique for promotions that are made via newspaper coupons. These techniques can also quickly become too complex when adjustments are made in an attempt to account for linear representations of what are typically non-linear relationships. This creates scalability issues for techniques used by the organization to forecast demand.

For example, a large grocery chain may have 50,000 products in 1,000 stores nationwide. The possible cannibalization or affinity relationships can include 50,000,000 potential product-store combinations. As a result of this complexity and the volume of necessary computations, many organizations will circumscribe their techniques for determining demand forecasting with respect to products that are related to promoted products. Thus, because of scaling issues demand forecasting is not fully deployed, implemented, and/or leveraged within an organization.

Therefore, there exist needs for providing techniques, methods, and systems that better forecast demand for products with cannibalized and affinity effects. With such techniques, methods, and systems, organizations can more timely and efficiently plan their inventory and purchasing decisions. Moreover, any such technique should be scalable to handle practical organizational product environments.

### SUMMARY OF THE INVENTION

In various embodiments of the present invention methods and systems are described to located relevant reports. More specifically, and in one embodiment, a method to determine demand forecast for products is presented. A related product identification associated with a related product is received. The related product is related to a promoted product. Furthermore, a promoted product identification associated with the promoted product is received. Next, historical demand data for the related product during a historical period of time in which the promoted product was promoted is acquired by using the product identifications. Finally, a projected demand forecast for the related product is determined by using the historical data.

In still another embodiment of the present invention, another method to determine demand forecast for products is described. Initially, related product and promoted product identifications associated with a related product and a promoted product, respectively, are received. Moreover, using the product identifications a historical period of time surrounding a promotion period of time during which the promoted product was promoted is identified. Then, a historical demand for the related product during the historical period of time is identified. Finally, a projected demand for the related product is determined by assuming the promoted product is promoted during a projected period of time.

In yet another embodiment of the present invention, a product demand forecasting system is presented. The product demand forecasting system includes a data store, an interface application, and a demand forecasting application. The demand forecasting application receives related product and promoted product identifications from the interface application. Furthermore, the related product and promoted product identifications are associated with a related product and a promoted product, respectively. The demand forecasting application also uses the identifications to acquire historical demand data for the related product during a period of time that includes a promotion for the promoted product. The historical data is used to forecast a projected demand for the related, product when the promoted product is promoted.

Still other aspects of the present invention will become apparent to those skilled in the art from the following description of various embodiments. As will be realized the invention is capable of other embodiments, all without departing from the present invention. Accordingly, the drawings and descriptions are illustrative in nature and not intended to be restrictive.

### BRIEF DESCRIPTION OF THE DRAWING

FIG. 1 is a diagram representing an example graph depicting the demand relationships among sample products, according to the teachings of the present invention;

FIG. 2 is a flow diagram representing a method for determining demand forecast of products, according to the teachings of the present invention;

FIG. 3 is a flow diagram representing another method for determining demand forecast of promoted products, according to the teachings of the present invention;

FIG. 4 is a diagram representing a product demand forecasting system, according to the teachings, of the present invention;

FIG. 5A is a diagram representing an example demand forecast for a promoted product, according to the teachings of the present invention; and

FIG. 5B is a diagram representing an example demand forecast for a cannibalized product, according to the teachings of the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

In various embodiments of the present invention, product data is housed in a data store. In one embodiments, the data store is a data warehouse, such as the Teradata warehouse, distributed by NCR Corporation of Dayton, Ohio. Various data store applications interface to the data store for acquiring and modifying the product data. Of course as one of ordinary skill in the art readily appreciates, any data store and data store applications can be used with the teachings of the present disclosure. Thus, all such data store types and applications fall within the scope of the present invention.

Moreover, as used herein a related product is a product that is either positively affected or negatively affected by a promotion of a promoted product. Products with positive relationships to the promoted product are referred to as affinity products. Products with negative relationships to the promoted product are referred to as cannibalized products. Analysts that are familiar with an organization's product can identity affinity and cannibalized products. An analyst can determine affinity and cannibalized products through experience, observation, and/or through empirical evaluations. The analyst identifies the relationships between promoted products and affinity/cannibalized products by interfacing with the data store to create and establish the initial relationships.

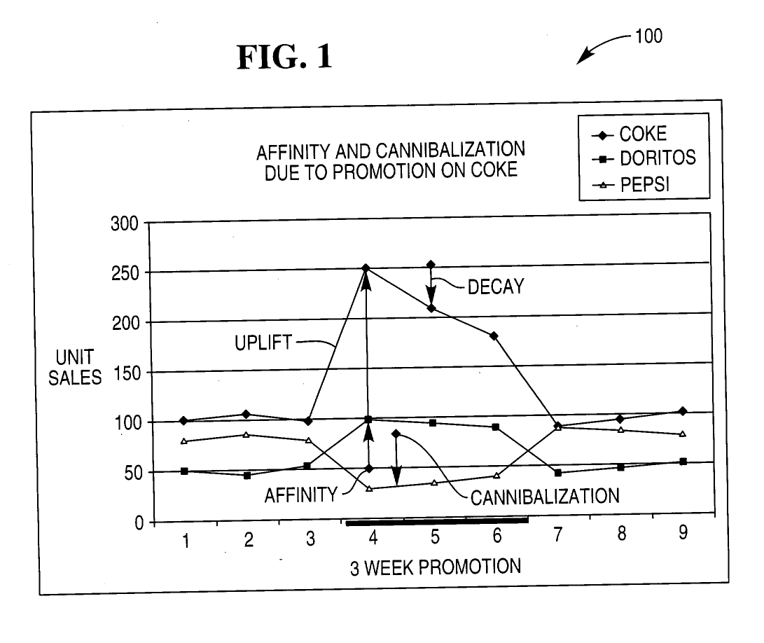

FIG. 1 illustrates a diagram representing an example graph 100 depicting the demand relationships among sample products, according to the teachings of the present invention. FIG. 1 is presented for purposes of illustration only as an example graph that can be produced with the demand forecast of the present invention for a promoted product as compared to related products.

In FIG. 1 the promoted products are Coca-Cola soft drinks and the related products are Doritos® snack chips and Pepsi-Cola soft drinks. It can be easily visualized with the produced graph that when Coca-Cola or Coke soft drinks are promoted they experience uplift in demand for the promotion period depicted between weeks 4 and 6. Initially, Coke sees a steep uplift during the initial week 4 of the promotion: Coke then experience decay in weeks 5 and 6 of the promotion, but still sees an increase in demand beyond what may be expected if the promotion were not occurring.

It is also readily visualized that the Doritos product has an affinity relationship with the Coke promotion, since the Doritos product experiences an increased demand during the Coke promotion. Conversely, Pepsi-Cola soft drinks are cannibalized by the Coke promotion and they experience a decrease in demand during the Coke promotion.

Using the teachings of the present invention, the graph 100 can be automatically produced and presented using existing graphical and/or report tools, since a related product's projected demands are accurately adjusted based on historical analysis of past demand data for the related product when the promoted product is promoted. This visualization can assist analyst in determining the effects of promotions for related products and more accurately allow the analysts to adjust purchasing, planning, and inventory models for the related products.

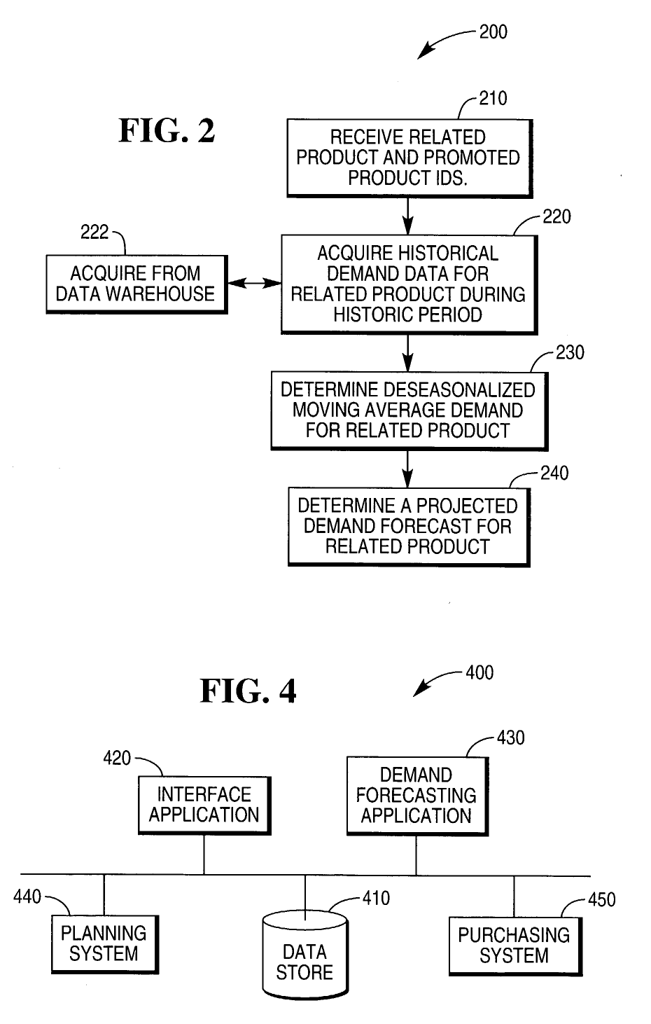

FIG. 2 illustrates a flow diagram representing a method 200 for determining demand forecast of products, according to the teachings of the present invention. The method 200 can be implemented as a stand-alone software tool, or it can be embedded within existing forecasting software tools. In one embodiment, the method 200 is implemented within the Teradata Demand Chain Management suite of products, distributed by NCR Corporation of Dayton, Ohio.

Initially, a business analyst having experience or empirical knowledge identifies a related product to a product that may be placed on promotion. The related product can be a product that has an affinity relationship or a cannibalized relationship to the promoted product. The related product and promoted product can be represented with unique identifiers in an electronic environment. The identifiers can be selected from a Graphical User Interface (GUI) application, Text User Interface (TUI) application, Unix System User Interface (UI) application, or any other command user interface application. In some embodiments, the analyst can also enter or select a textual description of the related product and the promoted product using a user interface application, where other applications will automatically convert the textual description into the appropriate unique identifiers for the products.

Historical sales data associated with the historical sales data of the promoted product and the related product are available in a data store. In one embodiment of the present invention the data store is a data warehouse, such as the Teradata warehouse, distributed by NCR Corporation of Dayton, Ohio.

Accordingly, at 210, the method 200 directly or indirectly receives the related product identifier and the promoted product identifier. These identifiers are then used, at 220, to acquire historical demand sales data for the related product during a configurable historical period of time during which the promoted product was previously promoted. The configurable historical period of time includes time before and after the promotion for the promoted product. The amount of time included before and after the promotion can be inputted as a parameter (e.g., manually, via a file, via an environment variable, and the like) to method 200, or hard coded within the method 200.

Once the historical period of time is discerned, the historical demand data is acquired from the data store for the entire historical period of time. As previously presented, and in one embodiment, the historical demand data for the related product is acquired from a data warehouse using the identifiers and the historical period of time as query terms, as depicted at 222.

Next, at 230, a deseasonalized moving average demand is determined from the historical demand data. The, deseasonalized moving average demand can be an average based on any configurable unit of time. For example, in one embodiment, the deseasonalized moving average demand is based on a week (e.g., unit of time) of demand. The deseasonalized moving average demand excludes units of time during which the promoted product was being promoted, since this may skew or taint the deseasonalized moving average demand forecast. For example, if the historical period of time is 7 weeks in duration, where each unit of time is measured in weeks and the promoted product was promoted in weeks 4, 5, and 6, then the deseasonalized moving average demand for weeks 4 through 6 would be the demand or units sold of the related product during weeks 1 through 3 divided by 3 (e.g., the first three weeks of the historical period or time during which no promotion was occurring). Moreover, the deseasonalized moving average demand for week 8 would be the demand or units sold of the related product during weeks 1, 2, 3, and 7 divided by 4 (the promotion weeks are excluded from the deseasonalized moving average demand calculation).

Once the deseasonalized moving average demand for the related product is determined, the projected demand forecast can be determined at 240. The projected demand can be represented as a multiplier or coefficient that can be applied to future projected promotions of the related product in order to adjust the future demand or units sold for the related product during the projected period of time during which the promoted product is to be promoted. If the related product has an affinity relationship with the promoted product, then the multiplicative coefficient will be greater than 1 or positive. If the promoted product cannibalizes the related product, then the multiplicative coefficient will be less than 1 or have a negative relationship to the related product's demand.

In order to determine the projected demand forecast for the related product, the historical demand for the related product is evaluated to determine what past demand was during the historical period when the promoted product was on promotion. This demand is then divided by the deseasonalized moving average demand, as discussed in detail above, to calculate a promotional coefficient. This calculation provides a multiplicative coefficient for each unit of time (e.g., weeks, and the like) during which the promoted product was previously promoted. The coefficients can then be used as multipliers against projected demands for the related product during some future units of time (e.g., weeks, and the like) that the promoted product is actually or believed to be on promotion.

For example, if the historical data indicates that during a historical period of time identified by 8 units of time represented as weeks that the promoted product was promoted in weeks 4 through 6, then a promotional coefficient for the related product can be determined for weeks 4 through 6. If the moving average of demand for thee related product in weeks 1 through 3 was 100 and the demand for weeks 4 through 6 was 110, 120, and 105, respectively, then the coefficients are 1.1 (110/100), 1.2 (120/100), and 1.05 (105/100) for weeks 4, 5, and 6, respectively. In the present example, since the related product's coefficients are greater than 1 the related product has an affinity relationship with the promoted product. Armed with these coefficients and projected demands for the related product for a projected period of time, the projected demands can be adjusted by multiplying the projected demands by the promotional coefficients when the promoted product is placed on promotion. This will result in an increase demand projection for the related product, and allow ant organization to increase production, purchasing, and inventory for the related product in a more timely fashion during the period that the promoted product is promoted. In a similar fashion, the related product could be cannibalized by the promoted product resulting in a coefficient that is less than one, and it can be used with future planning projects to reduce production, purchasing, and inventory during periods that the promoted product is promoted.

As one of ordinary skill in the art now appreciates, the embodiments of method 200 permit an organization to more timely adjust demand forecasts for related products to control purchasing, planning, and inventory for the related products. This will increase the efficiency and profitability of the organization. Moreover, the techniques described above are achieved in a non-linear fashion, unlike traditional approaches, which have become unduly complicated and largely linear (e.g., attempting to model all variables in a single solution, or isolating variables into separate solutions). The present technique is also more scalable and easily integrated within an organization's environment to produce more timely and efficient demand forecasts.

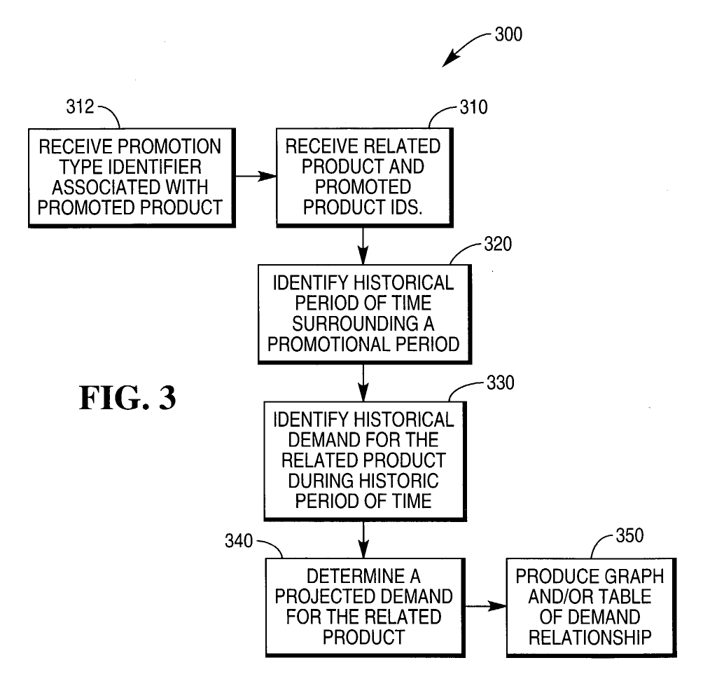

FIG. 3 illustrates a flow diagram representing another method 300 for determining demand forecast of products, according to the teachings of the present invention. Like FIG. 2, method 300 can be implemented as a standalone software tool or embedded within existing demand forecasting tools within an organization. All such standalone or existing products that are modified to achieve the tenets of the present disclosure are intended to fall within the scope of the present invention.

At 310, an analyst directly or indirectly supplies a related product identifier. Moreover, at 312, the analyst directly or indirectly supplies a promoted product identifier. Once the identifiers are received, then a historical period of time surrounding a historical promotion period for the promoted product is identified, as depicted at 320. The historical period of time includes time before the previous promotion and, optionally, time after a previous promotion. The period is broken down into units of time such as days, weeks, months, quarters, years, and the like. Both the historical period of time and the units of time are items that can be configured within method 300.

At 330, the identifiers, units of time, and the historical period of time is used to query a sales data store, such as a data warehouse, a database, and the like, in order to acquire historical demand data for the related product for each unit of time defined within the historical period of time. A deseasonalized moving average demand is then calculated for each unit of time for the related product. The deseasonalized moving average demand carries over from a previous deseasonalized moving average demand for the units of time during which a previous promotion occurred for the promoted product. In other words, the deseasonalized moving average demand is not affected by demand increases or decreases for the related product during units of time when the promoted product was on promotion. This will prevent biasing or skewing of the demand for the related product when determining a projected demand for the related product.

Once the historical demand for the related product is acquired for all units of time within the historical period of time and once the moving averages of demand for the units of time are determined, a projected demand for each unit of time for the related product is determined at 330. This is acquired by dividing the demand for the related product by the associated moving average to produce a projected demand coefficient for each unit of time during which the promoted product was previously promoted. The coefficient can then be applied to projected demand during periods during which the promoted product is promoted in order to accurately adjust the demand for the related product. As previously presented, affinity relationships produce coefficients that are greater than 1, while cannibalized relationships produce coefficients that are less than 1.

In some embodiments, the historical sales demand data can also include a promotion media type associated with the promoted product. The type can represent a type of promotion used for the promoted product. For example, a type can be advertisements made for the promoted product through a print media (e.g., newspaper), online media (e.g., electronic mail (email), World-Wide Web (WWW), and the like), telemarketing, postal mail, television, and others. Thus, the coefficients may be different depending upon the type of media used to promote the promoted product. The method 300 can accurately reflect these different promotion types without complicated linear modules as would be required by existing techniques.

Moreover, in some embodiments at 340, the resulting coefficients can be applied to projected demand modules for the related product to produce graphs, tables, and other demand relationships. These visual aids assist an organization in visualizing and analyzing the demand affects associated with affinity and cannibalization of related organizational products when promoted products are promoted. In some cases these aids can be integrated with Online Analytical Processing (OLAP) tools and can be interactively manipulated by an analyst to evaluate different conditions in order to further enhance the teachings of the present disclosure.

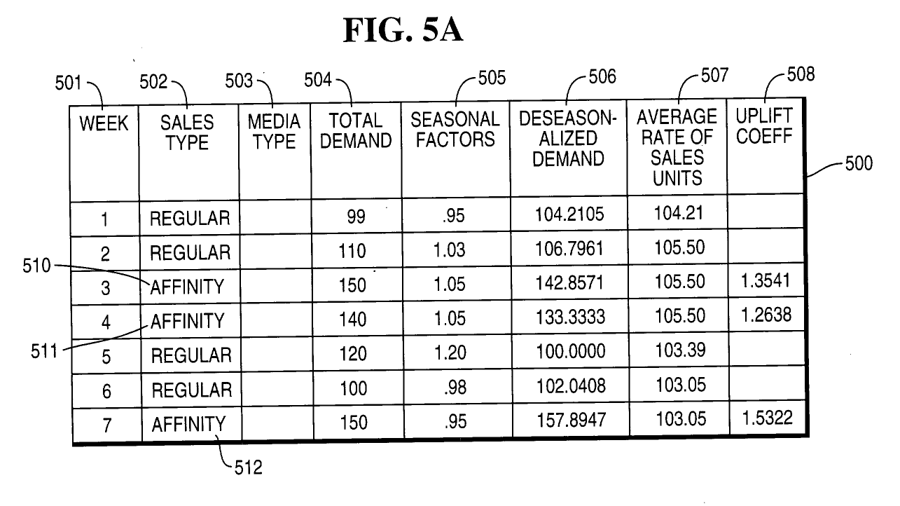

FIG. 4 illustrates a diagram representing a product demand forecasting system 400, according to the teachings of the present invention. The product demand forecasting system 400 includes a data store 410, an interface application 420, and a demand forecasting application 430. Optionally, the product demand forecasting system 400 is also interfaced with an organization's planning system 440 and purchasing system 450. The demand forecasting system 400 is implemented in a computing environment and can be a standalone system or a system where the components are networked together.

The demand forecasting application 430 receives related product and promoted product identifiers from the interface application 420. An analyst can provide these identifiers and relationships through a front-end interface of the interface application 420. In some embodiments, the demand forecasting application 430 need not receive the promoted product identifiers, in these instances the demand forecasting system 400 needs to be able to identify a historical period of time during which a promoted product was promoted even if the promoted product is not specifically identified. The demand forecasting application 430 uses the identifiers to acquire historical demand data for the related product during a historical period of time. The historical period of time includes units of time before the promoted product was promoted, units of time during which the product was promoted, and, optionally, units of time after the promoted product was no longer being promoted. The historical period of time is configurable within the product demand forecasting system 400 or can be supplied via the interface application 420 from an analyst.

The demand forecasting application 430 uses the historical period of time, the units of time, and the identifiers to query the data store 410 in order to acquire historical demand data for the related product for each unit of time included within the historical period of time. In one embodiment, the data store 410 is a data warehouse, such as the Teradata warehouse, distributed by NCR, Inc., of Dayton, Ohio. Moreover, the demand forecasting application 430 can be embedded within utilities provided by the data store 410.

After the demand forecasting application 430 queries the data store 410, a plurality of answer set records are returned to the demand forecasting application 430. Each record at a minimum provides the unit of time for the historical period of time and a historical demand for the related product during the specified unit of time. Optionally, each record can also include seasonal adjustments to the demand based on seasonal factors affecting demand for the related product, and a promotion type (e.g., media channel, print, online, television, direct, and others) associated with a promoted product's previous promotion.

The demand forecasting application 430 analyzes each record returned to produce a deseasonalized moving average demand for each unit of time for the related product. The deseasonalized moving average demand is not altered for the units of time during which promoted product was promoted. Next, the demand of the related product is divided by its deseasonalized moving average demand to produce a projected demand represented as a coefficient or multiplier. The coefficient can depict an affinity relationship between the promoted product and the related product when the coefficient is greater than 1. Furthermore, the coefficient can depict a cannibalized relationship between the promoted product and the related product when the coefficient is less than 1. The calculated coefficients can then be applied to projected demand for the related product when the promoted product is subsequently promoted in order to adjust the demand projections for the related product. This will assist an organization in more accurately adjusting demand projections for the related product in order to control planning, purchasing, and inventory more efficiently.

In some embodiments, the demand forecasting application 430 can be interfaced directly to an organization's planning system 440 and/or purchasing system 450. In this way, the determined coefficients representing projected demand for the related product can be used to automatically and efficiently adjust these organizational systems. Moreover, in some embodiments, the demand forecasting application 430 can be interfaced to one or more presentation applications to visually depict the demand relationship between a promoted product on promotion and a related product.

Additionally, in one embodiment, each record returned from the query to the data store 410 can include a promotion or media type identifier that specifically identifies a type of promotion that occurred historically for a promoted product during the returned unit of time. In this way, the determined coefficients can more accurately reflect the effects that a promotion has on the related product. This is achieved without complicated linear regression techniques that have been used in the past.

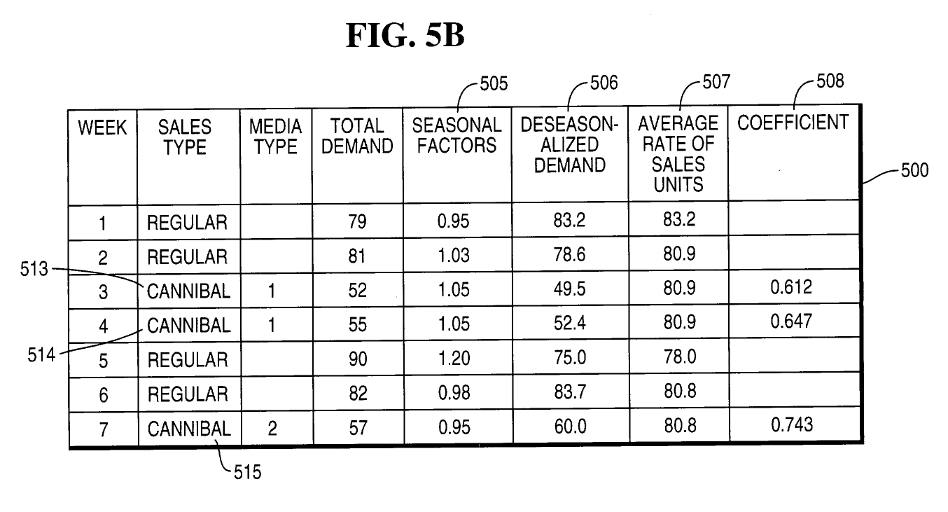

FIG. 5A illustrates a diagram representing an example demand forecast for a promoted product, according to the teachings of the present invention. FIG. 5A is presented for purposes of illustration only and is not intended to limit the present invention to the example as shown in FIG. 5A. The example is depicted as a table 500 that includes a historical period of time for historical demand data for a related product. The historical period of time includes 7 units of time represented as column 501 labeled weeks.

The sales type column 502 indicates when the promoted product was promoted and when it was not promoted during the 7-week historical period of time. The historical period of time includes units of time (e.g., weeks 501) during which the promoted product was promoted and during which the promoted product was not promoted. The media type column 503 identifies the type of media or promotion used when the promoted product was promoted. The total demand column 504 indicates the demand normally expected for the related product during this particular unit of time. The seasonal factors column 505 is adjustments to the demand based on seasonal factors. The deseasonalized demand column 506 represents the demand column 404 multiplied by the seasonal factors column 505 to produce the actual demand for the related product during a specified unit of time.

The average rate of sales units column 507 represents a calculated deseasonalized moving average demand for the related product for a specified unit of time. The deseasonalized moving average demand is initially the deseasonalized demand for week 1. In week 2 the deseasonalized moving average demand is week 1's deseasonalized demand plus week 2's deseasonalized demand divided by 2 to produce a deseasonalized moving average demand for the related product of 105.5. In weeks 3 and 4 the deseasonalized moving average demand is unchanged from week 2, since in weeks 3 and 4 the promoted product is being promoted.

The projected demand or uplift coefficient column 508 is the deseasonalized demand divided by the moving average. So, for week 3 the uplift coefficient is 1.3541 510. In week 4 or the second week of the promotion for the promoted product the related product has an uplift coefficient of 1.2638 511. Both coefficients for weeks 3 and 4 are greater than one indicating that the related product has an affinity relationship with the promoted product. Moreover, during the second week of the promotion or week 4 the coefficient declined from the first week of the promotion or week 3. This decline is referred to as decay.

The promoted product was also promoted in week 7 of the historical period of time. Notice, that the deseasonalized moving average demand was adjusted in weeks 5 and 6 following the promotion weeks of 3 and 4, and that the moving average for week 6 was carried forward for week 7, since in week 7 a promotion is occurring. Also, notice that the media type or promotion type for week 7 is different from what was used for the promotion in weeks 3 and 4. It could be that in week 7 a television promotion was used while in weeks 3 and 4 a newspaper advertisement was used. Thus, the promotion used in week 7 was more effective than that which was used in weeks 3 and 4, since the uplift coefficient of week 7 is 1.5322 512, which is much higher than that which was produced in weeks 3 and 4 of the promotion.

The calculated uplift coefficients can be used in planning demand for the related product by using the uplift coefficients as a multiplier against projected demand for the related product when the promoted product is subsequently promoted. The coefficients can adjust demand during extended weeks of the promotion and for the type of promotion being used for the promoted product.

FIG. 5B illustrates a diagram representing an example demand forecast for a cannibalized product, according to the teachings of the present invention. Again, FIG. 5B is presented for purposes of illustration only and is not intended to limit the present invention to the example depicted. In FIG. 5B the uplift coefficient column 508 is depicted as a coefficient that actually decreases the demand for the related product when a promoted product is promoted. This represents a cannibalized relationship between the promoted product and the related product.

In FIG. 5B during the promotion weeks of 3 and 4 for the promoted product, the related product experiences a decrease in demand. As a result, the coefficient for week 3 is 0.612 513 and for week 4 is 0.647 514. However, in week 7 when a different promotion or media type was used the decrease in demand was not as severe and is depicted as 0.743 515. These coefficients can be multiplied against projected related product demand forecast when the promoted product is promoted to adjust demand projections downward.

As one of ordinary skill in the art now appreciates, the calculated coefficients can be used as projected demand multipliers by and organization to adjust demand forecast for a related product when a promoted product is promoted. This will more efficiently permit an organization to control planning, purchasing, and inventory resulting in improved profits for the organization.

The foregoing description of various embodiments of the invention has been presented for purposes of illustration and description. It is not intended to be exhaustive nor to limit the invention to the precise form disclosed. Many alternatives, modifications, and variations will be apparent to those skilled in the art in light of the above teaching. For example, although various embodiments of the invention have been described as a series of sequential steps, the invention is not limited to performing any particular steps in any particular order. Accordingly, this invention is intended to embrace all alternatives, modifications, equivalents, and variations that fall within the spirit and broad scope of the attached claims.

What is claimed is:

1. A method to determine demand forecast for products, comprising:
receiving a related product identification associated with a related product, wherein the related product is related to a promoted product;
receiving a promoted product identification associated with the promoted product;
acquiring historical demand data for the related product during a historical period of time during which the promoted product was promoted by using the product identifications; and
determining a projected demand forecast for the related product by using the historical data.

2. The method of claim 1 wherein in acquiring the historical demand data for the related product, the historical demand data is acquired from a data warehouse.

3. The method of claim 1 wherein in acquiring the historical demand data for the related product, the historical period of time includes periods during which the promoted product was promoted and periods during which the promoted product was not promoted.

4. The method of claim 1 wherein in determining the projected demand forecast, the projected demand forecast is less than 1 indicating the promoted product is cannibalizing the related product.

5. The method of claim 1 wherein in determining the projected demand forecast, the project demand forecast is greater than 1 indicating the promoted product has an affinity relationship with the related product.

6. The method of claim 1 wherein in determining the projected demand forecast, the projected demand forecast is represented as a multiplier that is applied to a historical demand for the related product based on a moving average for the historical demand in order to forecast a related product demand.

7. The method of claim 1 wherein in determining the projected demand forecast, the projected demand forecast is determined by dividing a historical demand for the related product by a moving average of historical demand for the related product, and wherein the moving average excludes demand of the related product during a promotion period of the promoted product.

8. A method to determine demand forecast for products, comprising:
receiving related product and promoted product identifications associated with a related product and a promoted product, respectively;
identifying a historical period of time surrounding a promotion period of time during which the promoted product was promoted by using the product identifications;
identifying a historical demand for the related product during the historical period of time; and
determining a projected demand for the related product assuming the promoted product is promoted during a projected period of time.

9. The method of claim 8 further comprising, receiving a promotion type identifier associated with a promotion of the promoted product and using the promotion type when identifying the historical demand for the related product.

10. The method of claim 8 further comprising, producing a graph depicting a demand relationship between the promoted product and the related product for the projected period of time.

11. The method of claim 8 further comprising, producing a table depicting a demand multiplier effect on the projected demand for the related product during the projected period of time.

12. The method of claim 8 wherein in determining the projected demand, the projected demand indicates that the related product is cannibalized by the promoted product during a least a portion of the projected period of time.

13. The method of claim 8 wherein in determining the projected demand, the projected demand indicates that the related product experiences increased demand during a least a portion of the projected period of time.

14. The method of claim 8, wherein in determining the projected demand, the projected demand is represented as a coefficient or a weight that is to be applied against projected demand units for the related product during the projected period.

15. A product demand forecasting system, comprising:
a data store;
an interface application; and
a demand forecasting application that receives related product and promoted product identifications from the interface application, the related product and promoted product identifications are associated with a related product and a promoted product, respectively, and wherein the demand forecasting application uses the identifications to acquire historical demand data for the related product during a period of time that includes a promotion of the promoted product, and wherein the historical data is used to forecast a projected demand for the related product when the promoted product is promoted.

16. The product demand forecasting system of claim 15 wherein the data store is at least one of a database and a data warehouse.

17. The product demand forecasting system of claim 15 wherein the demand forecasting application uses one or more presentation applications to present the projected demand over a projected period of time.

18. The product demand forecasting system of claim 15 wherein the demand forecasting application receives a promotion type from the interface application and uses the promotion type in acquiring the historical data from the data store.

19. The product demand forecasting system of claim 15 wherein the demand forecasting application supplies the projected demand to at least one of a planning system and a purchasing system.

20. The product demand forecasting system of claim 19 wherein supplied projected demand is used by the systems to determine purchasing and inventory for the related product.
